(19) United States
(12) Patent Application Publication
(10) Pub. No.: US 2024/0110006 A1
(43) Pub. Date: Apr. 4, 2024

(54) SILANE-TERMINATED POLYMERS

(71) Applicant: MERZ+BENTELI AG, Niederwangen (CH)

(72) Inventors: Stefan HUBER, Langenthal (CH); Thomas ZUBER, Rubigen (CH); Fritz BURKHARDT, Oberburg (CH); Claude LERF, Meyriez (CH)

(73) Assignee: MERZ+BENTELI AG, Niederwangen (CH)

(21) Appl. No.: 18/274,790

(22) PCT Filed: Jan. 28, 2022
(86) PCT No.: PCT/EP2022/051972

§ 371 Date: Jul. 28, 2023

(30) Foreign Application Priority Data
Jan. 30, 2021 (EP) 21154466.3

(51) Int. Cl. C08G 63/91; C09J 167/02

(52) U.S. Cl. CPC C08G 63/916; C09J 167/02

(57) ABSTRACT

A process for preparing a storage-stable silane-terminated polymer of formula (I) or (II)

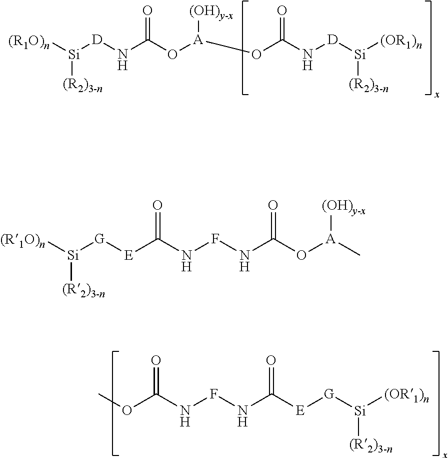

where D is linear or branched hydrocarbon group, A is polymer backbone selected from group, R1, R1′, R2 and R2′ are each linear, branched or cyclic hydrocarbon radical having 1 to 10 carbon atoms, n is 1, 2 or 3, x and y are natural numbers between 1 and 10, G is linear or branched hydrocarbon group having 1 to 20 hydrocarbon atoms, F is linear, branched or cyclic organic radical containing no isocyanate-reactive groups, m is natural number greater than 1, E is reactive group reacting with isocyanate group and selected from group consisting of NH2, NHR4 and SH, and R4 is linear, branched or cyclic hydrocarbon radical having 1 to 10 carbon atoms.

The present invention relates to a process for preparing silane-terminated polymers which may be used in sealants, adhesives and coating materials and which are storage-stable for a long period of time.

The silane-terminated polymers are prepared by known methods. A known method comprises, for example, the reaction of polyols, in particular hydroxyl-terminated polyethers, polyurethanes or polyesters, and also of hydroxyl-functional polyacrylates, with (isocyanatoalkyl)alkoxysilanes.

Another method provides for a reaction of the aforementioned polyols with di- or polyisocyanates, the latter being used in excess, so that isocyanate-functional polymers are produced in this first reaction step, which are then reacted in a second reaction step with alkoxysilanes having an alkyl-bonded isocyanate-reactive group.

The reaction of hydroxyl-functional polymers with isocyanates is carried out in the presence of additional catalysts, since only in this way is it possible to achieve sufficiently high reaction rates for economical production of the alkoxysilane-terminated polymers in the relevant reaction step.

EP 1 995 261 A1 discloses prepolymers containing alkoxysilane groups based on specific, low-viscosity polyester polyols having a particularly high strength, a process for the preparation thereof and use thereof as binders for adhesives, primers or coatings. As mentioned for example in WO2005090428, organotin compounds are used to prepare an OH-functional prepolymer and for capping said prepolymer or the polyester polyol in order to accelerate the reaction. Organotin compounds have the disadvantage that they adversely affect the storage stability of the adhesive by transesterification of the polyester backbone. Another problem with tin catalysts is that they are difficult to remove completely after the reaction and are both of toxicological and ecological concern.

WO 2010/136511 discloses silane-functional polyesters which are used as a constituent in moisture-curing compositions such as adhesives, sealants or coatings based on silane-terminated polymers.

Various processes for preparing silane-terminated polymers are described in the literature. EP 3 744 748 A1 discloses a process for preparing silane-terminated polymers, in which the urethanization reaction is carried out in the presence of at least one catalyst which is free from organically bound tin. US2019/0031812 discloses a process for preparing silane-terminated polymers. The reaction is carried out in the presence of bismuth neodecanoate. U.S. Pat. No. 9,321,878B2 (D3) discloses processes for preparing silane-terminated polymers in the presence of a tin-free catalyst. EP 2 930 197 discloses a silane-terminated adhesive for grouting joints in marine applications. Described here is the reaction of a polypropylene ether polyol with IPDI and diethyl N-(2-triethoxysilylpropyl)aminosuccinate in the presence of a titanium catalyst. US2017/0240689 discloses a process for preparing silane-terminated polymers by reacting a polypropylene glycol with IPDI, (isocyanatopropyl)triethoxysilane and/or and N-(2-triethoxysilylpropyl)-2-hydroxypropanamide in the presence of bismuth neodecanoate. US2020/0339729 discloses a process for preparing silane-terminated polymers by reacting polypropylene glycol with IPDI, (3-isocyanatopropyl)trimethoxysilane and diethyl N-(2-triethoxysilylpropyl)aminosuccinate.

The use of bismuth catalysts, as described, for example, in EP 1 535 940, results in high catalytic activity and thus in acceleration of the reaction of isocyanatosilanes with the hydroxy-terminated polyol. However, the polyol to be reacted with an isocyanate-functional compound must be dried prior to using a bismuth catalyst in order to avoid a side reaction of the isocyanate function with the water that would otherwise be present, which impairs the activity of bismuth catalysts. This additional effort is a significant disadvantage of the proposed reaction. In addition, bismuth catalysts cannot be used for preparing hydroxy-terminated polyols, particularly hydroxy-terminated polyesters and hydroxy-terminated polycarbonates.

WO 2020/035154 discloses that a reaction using a bismuth catalyst having water contents of less than 250 ppm is possible without greatly limiting the activity. In this way, the drying effort can be limited, but not avoided. In addition, adhesives, sealants and coating materials comprising polymers produced using bismuth catalysts exhibit a significant increase in viscosity during storage and therefore poor storage stability.

The object of the present invention is to provide an efficient process for preparing a silane-terminated polymer having excellent storage stability.

The object is achieved by the method according to the invention. Preferred embodiments are the subject matter of the dependent claims.

Surprisingly, it has been found that a silane-terminated polymer of the formula (I) or (II)

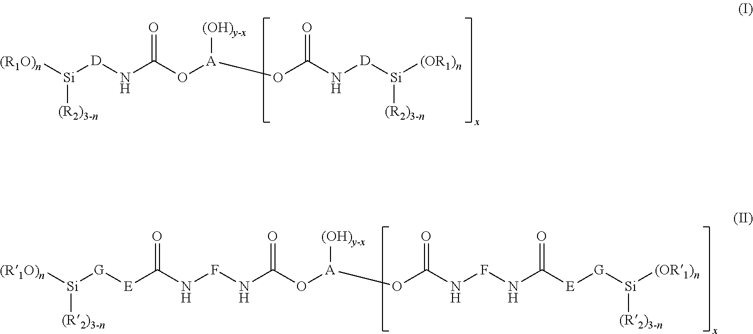

can be prepared by the process according to the invention, which exhibits a markedly high storage stability in adhesives, sealants and coating materials.

By means of the process according to the invention, it is possible to avoid the degradation of the polymer backbone selected from the group consisting of a polycarbonate, a polyester, a copolymer comprising a polyester and/or a polycarbonate and a polymer comprising at least one ester group and/or carbonate group. These polymer backbones can be degraded by the presence of a tin catalyst, which may be avoided by the process according to the invention. The degradation of the polymer chain—or even a break in the polymer chain of the silane-terminated polymer—results in a significant reduction in the mechanical properties after storage of the composition. In the present invention, it was found that even traces of a tin catalyst used in the production of the reactant can lead to such degradation. It is therefore very important that the reactants used are also free from a tin catalyst.

According to the invention, the silane-terminated polymer of the formula (I) is prepared by reacting a hydroxy-terminated organic polymer of the formula (III)

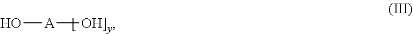

with an isocyanate of the formula (IV)

R²₃₋ₙ(R¹O)ₙSi-D-NCO (IV),

and
the silane-terminated polymer of the formula (II) is obtained by reacting a hydroxy-terminated organic polymer of the formula (III)

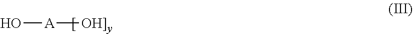

with a multi-functional isocyanate of the formula (V)

F—(N═C═O)ₘ

and subsequent reaction with an alkoxysilane of the formula (VI)

R^{2′}₃₋ₙ(R^{1′}O)ₙSi-G-E (VI).

The reaction is carried out in the presence of a catalyst. In the compounds of the general formulae I and II
D is a linear or branched hydrocarbon group having 1 to 20 hydrocarbon atoms, which may optionally be interrupted by heteroatoms selected from the group consisting of oxygen, nitrogen and sulfur,
A is a polymer backbone selected from the group consisting of a polycarbonate, a polyester, a copolymer comprising a polyester and/or a polycarbonate and a polymer comprising at least one ester group and/or carbonate group,
R₁, R₁′, R₂ and R₂′ are each independently a linear, branched or cyclic hydrocarbon radical having 1 to 10 carbon atoms, which may optionally comprise one or more heteroatoms selected from the group consisting of oxygen, sulfur and nitrogen,
n is 1, 2 or 3,
x and y are natural numbers between 1 and 10,
F is a linear, branched or cyclic organic radical which does not comprise any isocyanate-reactive groups, i.e. in particular comprises neither primary nor secondary amine groups,
G is a linear or branched hydrocarbon group having 1 to 20 hydrocarbon atoms, which may optionally be interrupted by heteroatoms selected from the group consisting of oxygen, nitrogen and sulfur,
m is a natural number greater than 1,
E is a reactive group that reacts with the isocyanate group and is selected from the group consisting of NH₂, NHR⁴ and SH, where R⁴ is a linear, branched or cyclic hydrocarbon radical having 1 to 10 carbon atoms, which may optionally comprise one or more heteroatoms selected from the group consisting of oxygen, sulfur and nitrogen.

It is essential to the invention that, in the process according to the invention, both the reactants used and the reaction itself are free from a tin catalyst. The term tin catalyst is understood to mean any compound containing tin ions and/or organometallic tin compounds which can accelerate the preparation of the reactants used or the reaction. Typical tin catalysts are, for example, tributyltin, dibutyltin oxide, dioctyltin oxide, dibutyltin dilaurate, dioctyltin dilaurate, and fatty acid salts of tin such as tin(II) stearates or tin(II) laurates.

It was found that no tin catalysts may be used, not only in the reaction itself, i.e. in the reaction of the hydroxy-terminated organic polymer of the formula (III) and the isocyanate of the formula (IV), or in the reaction of the hydroxy-terminated organic polymer of the formula (III) and the multi-functional isocyanate of the formula (V) and the subsequent reaction with the alkoxysilane of the formula (VI), but in particular also the reactants, i.e. the hydroxy-terminated organic polymer of the formula (III), the isocyanate of the formula (IV), the multi-functional isocyanate of the formula (V) and the alkoxysilane of the formula (VI), must be free from tin catalysts in order to obtain a storage-stable sealant.

Tin catalysts are widely used in the preparation of hydroxy-terminated polyesters and polycarbonates, i.e. a hydroxy-terminated organic polymer of the formula (III) having a polyester or a polycarbonate backbone. At least traces of these remain as active catalysts in the prepolymer, which is then used as reactant for the production of silane-terminated polymers. In the sealants, adhesives or coating materials produced from the polymers, the tin catalysts result in degradation of the polymer chain of the silane-terminated polymer and thus in a significant reduction in the mechanical properties after storage of the composition, in particular in a significant reduction in the Shore A hardness and/or the tensile strength. The adhesive, sealant and coating compositions in which the silane-terminated polymers according to the invention are used are storage-stable for several months. No impairment of the mechanical properties is observed, especially also when the adhesive, sealant or coating compositions are stored at relatively high temperatures, for example at 50° C.

Preferably, the present process relates to the preparation of a silane-terminated polymer of the formula (I) by reacting a hydroxy-terminated organic polymer of the formula (III)

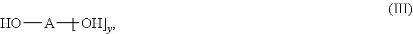

with an isocyanate of the formula (IV)

R²₃₋ₙ(R¹O)ₙSi-D-NCO (IV),

since this reaction involves only one reaction step and is therefore more cost-effective.

In one embodiment, the silane-terminated polymer relates to a linear polymer of the general formula IA

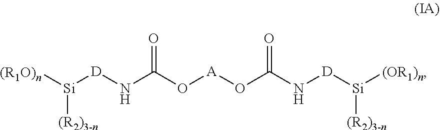

where R₁, R₂, D and n have the same definition as above. Linear silane-terminated polymers are particularly preferably used for sealants and coating materials that require greater elasticity, such as for joint compounds, elastic adhesives, surface sealants or in the marine sector, for example for grouting teak.

In a second embodiment, the silane-terminated polymer relates to a branched polymer of the general formula IB

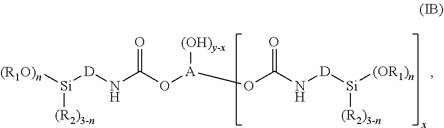

where R₁, R₂, D, n, x and y have the same definition as above. Preferably, the silane-terminated polymer of the formula IB is substantially free of free OH groups, i.e. y and x are essentially identical and the difference of y-x is therefore about 0. Branched silane-terminated polymers of the formula IB are used with particular preference for adhesive, sealant, and coating compositions that require a higher Shore A hardness and a higher crosslinking density, such as in the case of high-modulus adhesives, surface sealants, or floor coatings.

Preferably, no bismuth and/or zinc catalysts are used in the reaction either, as these catalysts have poor hydrolytic stability, may lead to side reactions and/or are complicated to handle. In particular, bismuth and/or zinc catalysts cannot be used for the preparation of the hydroxy-terminated polymer, especially for polyesters and polycarbonates. According to the present invention, however, the same catalyst is preferably used in the reaction as in the preparation of the hydroxy-terminated polymer, which is advantageous for ecological and economic reasons. In addition, adhesives, sealants and coating materials comprising polymers produced using bismuth catalysts exhibit a significant increase in viscosity during storage and therefore poor storage stability.

Preferably, at least one catalyst is used for the process according to the invention, which may be used both for the preparation of the hydroxy-terminated prepolymer and for the reaction of the isocyanatosilane with the hydroxy-terminated polymer and which does not adversely affect the storage stability of the adhesives, sealants and coating materials produced therefrom. The at least one catalyst is particularly preferably a titanium-containing organometallic compound, which may optionally also be combined with other catalysts such as lithium compounds. This further catalyst can optionally also be added only during the reaction of the hydroxy-terminated prepolymer and the isocyanatosilane. These catalysts do not adversely affect the storage stability of the adhesives, sealants and coating materials produced therefrom and do not have to be removed from the polymer in a complex manner.

The titanium-containing organometallic compounds, which are preferably used as catalysts in the process according to the invention, preferably comprise ligands which are selected from
an alkoxy group such as isobutoxy, n-butoxy, isopropoxy, ethoxy and 2-ethylhexoxy;
a sulfonate group such as aromatic sulfonates, the aromatic groups of which are substituted with an alkyl group and
a carboxylate group such as carboxylates of fatty acids;
a ketoester group such as acetoacetic ester derivatives; and
a dialkyl phosphate group,
   where all ligands may be identical or different from one another.

Alternatively or additionally, the titanium-containing organometallic compounds particularly preferably have at least one polydentate ligand as ligand, which enables chelation. The polydentate ligand is preferably a bidentate ligand.

The titanium-containing organometallic compounds are particularly preferably selected from the group consisting of bis(ethylacetoacetato)diisobutoxytitanium(IV), bis(ethylacetoacetato)diisopropoxytitanium(IV), bis(acetylacetonato)diisopropoxytitanium(IV), bis(acetylacetonato)diisobutoxytitanium(IV), tris(oxyethyl)amineisopropoxytitanium(IV), bis[tris(oxyethyl)amine]diisopropoxytitanium(IV), bis(2-ethylhexane-1,3-dioxy)titanium(IV), tris[2-((2-aminoethyl)amino)ethoxy]ethoxytitanium(IV), bis(neopentyl(diallyl)oxydiethoxytitanium(IV), titanium(IV) tetrabutoxide, tetra(2-ethylhexyloxy) titanate, tetra(isopropoxy) titanate, tetrabutyl titanate, tetraisopropyl titanate, tetra-2-ethylhexyl titanate and titanium acetylacetonate and polybutyl titanate. Tetrabutyl titanate and tetraisopropyl titanate are particularly preferred due to the good price-performance ratio.

The hydroxy-terminated organic polymer of the formula (III)

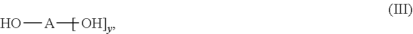

preferably has a polymer backbone A selected from the group consisting of polyesters, polycarbonates and copolymers comprising a polyester and/or a polycarbonate. The expression “copolymers comprising a polyester and/or a polycarbonate” is understood to mean polymers composed of two or more monomer units. In addition to alternating copolymers and graft copolymers, the term also includes, in particular, block polymers, which consist of longer sequences or blocks of each monomer and can be linked to one another via linker compounds. Preferred combinations of blocks are
polyesters and polycarbonates
various polyesters
polyesters and polyethers and also
polycarbonates and polyethers.

The expression “copolymer comprising a polyester and/or a polycarbonate” means a copolymer comprising at least one block composed of a polyester and/or a polycarbonate and containing further blocks. In such a copolymer, the polyester content or the polycarbonate content is at least 10% by weight, preferably at least 25% by weight and most preferably at least 50% by weight. In principle, the higher the polyester and/or polycarbonate content, the greater the risk of degradation of the polymer backbone.

Examples of this are the preferred combinations stated above. Preferred linker compounds are urethane, ester and amide compounds, particularly preferably urethane compounds.

The polymer backbone A comprises one or more ester and/or carbonate groups. They preferably comprise more than 2, particularly preferably more than 10 ester and/or carbonate groups. Within the present invention, the definition of the polymer backbone A also includes polymers extended with a linker compound, such as polymers terminally extended with a diol, polymers that have been dimerized or oligomerized by means of a diisocyanate or dicarboxylic acid dichloride, and copolymers which have been copolymerized using diisocyanates or dicarboxylic acid dichlorides. Such polymers may have 1, 2 or preferably 3 and more ester and/or carbonate groups within the polymer backbone. The higher the number of ester and/or carbonate groups, the higher the risk of polymer backbone degradation with the corresponding stability consequences for the final end product.

The expression hydroxy-terminated means polymers bearing free hydroxyl groups at the end of the molecule. y is a natural number from 1 to 10. In a preferred embodiment, y=1 and then corresponds to an a, w-dihydroxy-terminated organic polymer, i.e. a polymer having two terminal OH groups. If y is greater than 1, the hydroxy-terminated polyol has more than two terminal OH groups, i.e. it is a polyol of which the OH groups are intended to react with the isocyanate of the formula IV. In the case of branched hydroxy-terminated polymers, the OH groups are preferably not attached directly to the polymer backbone, but rather to the end of side chains of the polymer backbone. They can be obtained, for example, by reactions with polyols or polycarboxylic acids. Both linear and branched hydroxy-terminated organic polymers are known to those skilled in the art and are also commercially available.

Polycarbonates can be obtained, for example, by reacting diols such as propylene glycol, butane-1,4-diol or hexane-1,6-diol, diethylene glycol, triethylene glycol or tetraethylene glycol or mixtures of two or more thereof with diaryl carbonates, for example diphenyl carbonate or phosgene. However, the term polyester also includes polyester polyols which are formed by reacting low molecular weight alcohols or mixtures thereof, in particular ethylene glycol, diethylene glycol, propanediol, dipropylene glycol, neopentyl glycol, hexanediol, butanediol, pentanediol, hexanediol, propylene glycol, glycerol or trimethylolpropane, with caprolactone and the terminal hydroxyl groups thereof are then the hydroxyl groups of the organic polymer of the formula III. Particularly preferably, the polymer backbone comprises a branched diol component. Such a branched diol component of the low molecular weight alcohol used to prepare the polyester or polycarbonate is particularly preferably a branched diol selected from the group consisting of 3-methylpentane-1,5-diol, 2-methylpropane-1,3-diol, 3-ethylpentane-1,5-diol, propane-1,2-diol and 2,4-diethylpentane-1,5-diol, since the polymers produced therefrom have particularly good processability and durability.

A is particularly preferably a polycarbonate selected from the group consisting of polypropylene carbonate, polycyclohexene carbonate, poly(4,4′-isopropylidenediphenyl carbonate), poly(4,4′-diphenyl-1,1′-cyclohexane carbonate) and poly(propylene cyclohexene carbonate) or a polyester selected from the group consisting of poly(ethylene terephthalate) (PET), poly(ethylene naphthalate), poly(propylene terephthalate), polybutylene terephthalate (PBT), polycyclohexylenedimethylene-2,5-furan dicarboxylate (PCF), poly(butylene adipate-co-terephthalate) (PBAT), poly(butylene sebacate-co-terephthalate (PBSeT), poly(butylene succinate-co-terephthalate) (PBST), poly(butylene 2,5-furandicarboxylate-co-succinate) (PBSF), poly(butylene 2,5-furandicarboxylate-co-adipate) (PBAF), poly(butylene 2,5-furandicarboxylate-co-azelate) (PBAzF), poly(butylene 2,5-furandicarboxylate-co-sebacate) (PBSeF), poly(butylene 2,5-furandicarboxylate-co-brassylate) (PBBrF), polybutylene succinate (PBS), polybutylene adipate (PBA), poly(butylene succinate-co-adipate) (PBSA), poly(butylene succinate-co-sebacate) (PBSSe), polybutylene sebacate (PBSe) or a polyester polyol of at least one hydroxyl group-containing component selected from, for example, propane-1,2-diol, 3-methylpentane-1,5-diol, 2-methylpropane-1,3-diol, 3-ethylpentane-1,5-diol, 2,4-diethylpentane-1,5-diol, neopentyl glycol and 1,1,1-trimethylolpropane and mixtures thereof, and at least one carboxyl group-containing component selected from aliphatic acids having two carboxyl groups such as succinic acid, glutaric acid, adipic acid, pimelic acid, suberic acid, azelaic acid, sebacic acid, dodecanedioic acid, brassylic acid and dimer acids, or dialkyl esters of acids having two carboxyl groups such as dimethyl esters, diethyl esters, dipropyl esters and dibutyl esters or carboxylic acid chlorides such as acrylic or methacrylic acid chloride; alicyclic dicarboxylic acids such as 1,4-cyclohexanedicarboxylic acid or dialkyl ester acids having two carboxyl groups such as dimethyl esters, diethyl esters, dipropyl esters and dibutyl esters; aromatic acids having two carboxyl groups such as phthalic acid, isophthalic acid, terephthalic acid and naphthalenedicarboxylic acid, or dialkyl esters of acids having two carboxyl groups such as dimethyl esters, diethyl esters, dipropyl esters and dibutyl esters, and the like. Of these examples, preference is given to using adipic acid, azelaic acid, sebacic acid, terephthalic acid, isophthalic acid and naphthalenedicarboxylic acid. Also possible is the use of cyclic carboxylic anhydrides such as phthalic anhydride, maleic anhydride, succinic anhydride or with a side group such as 3-methylglutaric anhydride. Aliphatic dicarboxylic acids or esters thereof having side groups can also be used, such as 2,4-diethylglutaric acid, 2,4-methylglutaric acid, 3-methylglutaric acid, methylmalonic acid. Particularly preferred are polyester polyols and polycarbonates comprising, as hydroxyl group-containing component, a proportion of >10 mol % of a branched diol, such as 3-methylpentane-1,5-diol, 2-methylpropane-1,3-diol, 3-ethylpentane-1,5-diol, propane-1,2-diol, 2,4-diethylpentane-1,5-diol, as these have proven to be particularly stable. The proportion of the branched diol is particularly preferably >50 mol % of the diol used. The preferred dicarboxylic acids used are aliphatic dicarboxylic acids. The diols and also the dicarboxylic acids can be petroleum-based or have been produced from renewable raw materials.

Preferably, the hydroxy-terminated organic polymer is liquid at room temperature. This is understood to mean a viscosity at 20° C. of 1 to 106 mPa*s. This viscosity is optimal for handling the composition according to the invention, especially in the production of sealant preparations. This applies in particular to hydroxy-terminated polymers which have a homopolymer of a polycarbonate or a homopolymer of a polyester as the polymer backbone. In general, the polyesters according to the invention have a relatively low viscosity and are cost-effective. They are therefore more suitable for some applications than the polycarbonates according to the invention.

The hydroxy-terminated organic polymer preferably has an average molecular weight of 1000-20 000 g/mol, in particular 2000-12 000 g/mol, since the handling of said polymers is optimal. In this document, “molecular weight” is understood to be the molar mass (in grams per mole) of a molecule. The “average molecular weight” is the number-average molecular weight Mn of a polydisperse mixture of oligomeric or polymeric molecules, which is usually determined by titrating the acid number and OH number. The OH number (hydroxyl number) is a measure of the hydroxyl group content in polymers and is a quantity known to those skilled in the art. The acid number is a measure of the content of acid groups in polymers and is a quantity known to those skilled in the art.

The hydroxy-terminated organic polymers of the formula (III) used according to the invention may be commercially available compounds which, for better handling, can optionally be diluted with a plasticizer or solvent. However, it is important that they are produced tin-free, since even traces of a tin catalyst in the hydroxy-terminated organic polymer of the formula (III) adversely affect the storage stability of the silane-terminated polymer and especially of the adhesive, sealant and coating compositions produced therefrom. The same catalyst is preferably used in the preparation of the hydroxy-terminated organic polymer and the silane-terminated polymer, so that the catalyst does not have to be removed from the hydroxy-terminated organic polymer, which makes sense in process engineering terms and is more ecological.

The catalyst is preferably used in amounts of 0.5 to 500 ppm of the hydroxy-terminated organic polymer of the formula (III).

The isocyanates of the formula (IV) used according to the invention

R²₃₋ₙ(R¹O)ₙSi-D-NCO (IV)

are commercially available products or can be produced by standard methods in silicon chemistry. R₁ and R₂ are each independently a linear, branched or cyclic hydrocarbon radical having 1 to 10 carbon atoms, which may optionally comprise one or more heteroatoms selected from the group consisting of oxygen, sulfur and nitrogen. n may have the value 1, 2 or 3, with the values 2 or 3 being preferred, since the silane-terminated polymers produced therefrom have a particularly balanced reactivity.

Preferably, R¹ and R² are each independently alkyl radicals, such as a methyl radical, ethyl radical, n-propyl radical, isopropyl radical, n-butyl radical, isobutyl radical, tert-butyl radical, n-pentyl radical, isopentyl radical, neopentyl radical, tert-pentyl radical, n-hexyl radical, n-heptyl radical, octyl radicals, n-octyl radical, isooctyl radicals, 2,2,4-trimethylpentyl radical, n-nonyl radical, decyl radicals, n-decyl radical, dodecyl radicals or an n-dodecyl radical. They may, however, also be alkenyl radicals, such as a vinyl radical or an allyl radical; cycloalkyl radicals, such as a cyclopentyl radical, cyclohexyl radical, cycloheptyl radical and methylcyclohexyl radicals; aryl radicals, such as the phenyl radical and the naphthyl radical; alkaryl radicals, such as o-, m-, p-tolyl radicals, xylyl radicals and ethylphenyl radicals; aralkyl radicals, such as the benzyl radical, the α-phenylethyl radical and the β-phenylethyl radical. Examples of substituted radicals R¹ are alkoxyalkyl radicals, such as ethoxyethyl radicals and methoxyethyl radicals.

Preferably, radical R¹ and R² are each independently a hydrocarbon radical having 1 to 6 carbon atoms, particularly preferably an alkyl radical having 1 to 4 carbon atoms, in particular the methyl radical or ethyl radical.

D is a linear or branched hydrocarbon group having 1 to 20 hydrocarbon atoms, which may optionally be interrupted by heteroatoms selected from the group consisting of oxygen, nitrogen and sulfur. Preferably, D is selected from the group consisting of methylene, ethylene, propylene, butylene, methylene oxide, ethylene oxide and propylene oxide, and particularly preferably from propylene or methylene, since this results in polymers having a particularly balanced reactivity.

Examples of isocyanates of the formula (IV) are isocyanatomethyldimethylmethoxysilane, isocyanatopropyldimethylmethoxysilane, isocyanatomethylmethyldimethoxysilane, isocyanatopropylmethyldimethoxysilane, isocyanatomethyltrimethoxysilane, isocyanatomethyltriethoxysilane and isocyanatopropyltrimethoxysilane, preference being given to isocyanatomethylmethyldimethoxysilane, isocyanatopropylmethyldimethoxysilane, isocyanatopropyltrimethoxysilane, isocyanatopropyltriethoxysilane and isocyanatomethyltriethoxysilane.

The process according to the invention for preparing the silane-terminated polymer of the formula (II) is effected by reacting a hydroxy-terminated organic polymer of the formula (III)

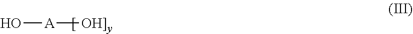

with a multi-functional isocyanate of the formula (V)

F—(N═C═O)ₘ

and subsequent reaction with an alkoxysilane of the formula (VI)

R^{2′}₃₋ₙ(R^{1′}O)ₙSi-G-E (VI),

it also being the case here that both the reactants used and the reaction are free from a tin catalyst.

Particularly suitable as multi-functional isocyanates of the formula (V) are isocyanates having two or more, preferably 2 to 10, isocyanate groups in the molecule. Suitable for this purpose are the known aliphatic, cycloaliphatic, aromatic, oligomeric and polymeric multi-functional isocyanates which do not comprise any isocyanate-reactive groups, i.e. in particular do not comprise free primary and/or secondary amino groups. A representative of the aliphatic multi-functional isocyanates is, for example, hexamethylene diisocyanate (HDI); a representative of the cycloaliphatic multi-functional isocyanates is, for example, 1-isocyanato-3-(isocyanatomethyl)-3,5,5-trimethylcyclohexane. The following may be mentioned as representatives of the aromatic multi-functional isocyanates: 2,4- and 2,6-diisocyanatotoluene and the corresponding technical isomer mixture (TDI); diphenylmethane diisocyanates, such as diphenylmethane-4,4′-diisocyanate, diphenylmethane-2,4′-diisocyanate, diphenylmethane-2,2′-diisocyanate and the corresponding technical isomer mixtures (MDI). In addition, mention should also be made of naphthalene-1,5-diisocyanate (NDI) and 4,4′,4″-triisocyanatotriphenylmethane.

Alkoxysilanes of the formula (VI) are preferably selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane and 7-amino-4-oxaheptyldimethoxymethylsilane, N-(2-aminoethyl)-3-aminopropyltrimethoxysilanes, N-(2-aminoethyl)-3-aminopropylmethyldimethoxysilanes, N-(2-aminoethyl)-3-aminopropyltriethoxysilanes, 3-[2-(2-aminoethylamino)ethylamino]propyltrimethoxysilane, 3-[2-(2-aminoethylamino)ethylamino]propyltriethoxysilane, 3-[2-(2-aminoethylamino)ethylamino]propylmethyldimethoxysilane,

[3-(1-piperazinyl)propyl]triethoxysilanes, [3-(1-piperazinyl)propyl]trimethoxysilanes, [3-(1-piperazinyl)propyl]methyldimethoxysilanes, N-(n-butyl)-3-aminopropyltrimethoxysilane, N-(n-butyl)-3-aminopropylmethyldimethoxysilane, N-(n-butyl)-3-aminopropyltriethoxysilane, N-ethylaminoisobutyltrimethoxysilane, N-ethylaminoisobutylmethyldimethoxysilane, N-cyclohexyl-3-aminopropyltriethoxysilane, N-cyclohexyl-3-aminopropyltrimethoxysilane, N-cyclohexylaminomethyltriethoxysilanes, N-cyclohexylaminomethyltrimethoxysilanes, N-cyclohexylaminomethyldimethoxymethylsilanes, bis(trimethoxysilylpropyl)amines, 3-mercaptopropyltrimethoxysilanes, 3-mercaptopropyltriethoxysilanes, 3-mercaptopropylmethyldimethoxysilanes.

In order to accelerate the urethane or urea bond, a further catalyst which does not adversely affect the storage stability of the products and the adhesives, sealants or coating materials produced therefrom may optionally be used.

Preferably, this catalyst consists of
alkali metal carboxylates such as lithium neodecanoate, lithium ethylhexanoate, lithium laurate, lithium stearate, potassium neodecanoate, potassium ethylhexanoate or potassium laurate;
alkaline earth metal carboxylates such as calcium trimethylhexanoate, calcium neodecanoate, calcium laurate, strontium ethylhexanoate or strontium laurate;
carboxylates of the transition group elements such as cobalt ethyl hexanoates, cobalt stearates, cobalt laurates, cobalt neodecanoates, manganese ethylhexanoates, manganese stearates, manganese laurates, iron stearates, iron ethylhexanoates, iron laurates, copper stearates, copper laurates, copper neodecanoates, copper ethylhexanoates,
carboxylates from the boron group such as indium and aluminum salts,
salts from the carbon group such as lead salts,
salts from the nitrogen group such as phosphorus salts and phosphorus esters or antimony salts;
tertiary amines such as tributylamine, 1,4-diazabicyclo[2.2.2]octane, 1,8-diazabicyclo[5.4.0]undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine or ethylmorpholinine;
ionic liquids such as ionic liquids based on ammonium, imidazolium, phosphonium, pyridinium, pyrrolidinium or sulfonium;
short-chain organic acids having 1 to 10 carbon atoms such as acetic acid and
inorganic acids such as phosphoric acid and its monoesters, for example butyl phosphate, dibutyl phosphate and propyl phosphate.

These further catalysts may be used individually or else in combination.

Very particularly preferably, the further catalysts are selected from the group consisting of lithium neodecanoate, lithium ethylhexanoate, lithium laurate, lithium stearate, manganese ethylhexanoate, manganese neodecanoate, manganese laurate, manganese stearate, cobalt ethylhexanoate, cobalt laurate, cobalt stearate and cobalt neodecanoates. Particularly preferably, the further catalyst is combined together with a titanium-containing organometallic compound.

The catalyst is preferably added in an amount of 1 to 1000 ppm, particularly preferably 5 to 500 ppm and very particularly preferably 5 to 200 ppm.

Particularly preferably, the linear silane-terminated polymers are selected from the group consisting of

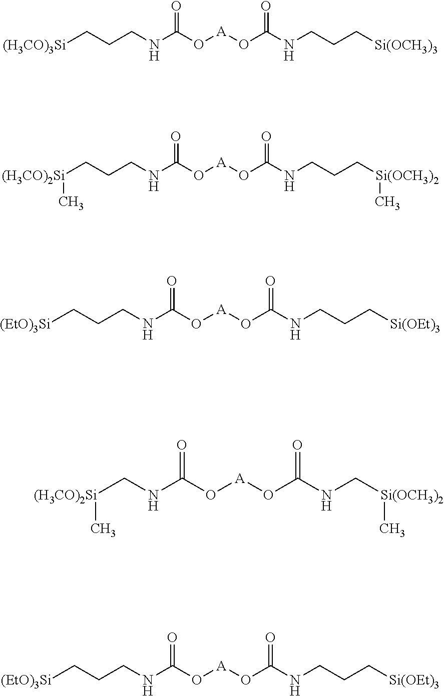

wherein

A is a polymer backbone as defined above.

The reaction is preferably carried out at temperatures between 50° C. and 150° C., particularly preferably at 60° C. to 120° C., and preferably at standard pressure.

The crosslinkable compositions prepared according to the invention are outstandingly suitable as sealing compounds for joints, including vertical joints, and similar empty spaces, for example of buildings, land vehicles, watercraft and aircraft, or as adhesives or cementing compounds, for example in window construction or in the production of showcases, and also for production of protective coatings or rubber-elastic moldings and for insulation of electrical or electronic devices. The compositions according to the invention are particularly suitable as sealing compounds for joints with possible high movement tolerance. The adhesives, sealants and coating materials according to the invention have significantly better weathering stability compared to standard products. As a result of the significantly better weathering stability, the coating materials according to the invention are particularly suitable for roof waterproofing and surface waterproofing or for coating other surfaces which are exposed to severe weathering.

The usual water content of the air is sufficient for the crosslinking of the composition according to the invention.

The crosslinking may be carried out at room temperature or, if desired, even at higher or lower temperatures, for example at −5° C. to 10° C. or at 30° C. to 50° C. The crosslinking is preferably carried out at standard pressure.

The silane-terminated polymers according to the invention may also be formulated as a 2-component system. In addition to auxiliaries, the second component also comprises water, which greatly accelerates deep through-curing after mixing with the first component. Corresponding 2-component systems are known to those skilled in the art and are described, for example, in EP2009063 or EP2535376, the content of which is incorporated by reference.

The preparations according to the invention may also comprise further auxiliaries and additives, which likewise must not comprise any tin catalysts. These auxiliaries and additives include, for example, further silane-terminated polymers, plasticizers, stabilizers, antioxidants, fillers, reactive diluents, drying agents, adhesion promoters and UV stabilizers, rheological aids, color pigments or color pastes and/or possibly also solvents to a small extent. Such auxiliaries and additives are known to those skilled in the art.

### EXAMPLES

### Example 1 (According to the Invention)

234 g of polyester polyol P-4010 (Kuraray Co, Ltd) synthesized using an organotitanate catalyst (titanium(IV) isopropoxide) and having a hydroxyl number of 28.7 mg KOH/g were heated to 90° C. with stirring. 22.4 g of (trimethoxysilyl)propyl isocyanate were added and stirred at 90° C. After 90 min, free isocyanate was no longer detected by FT-IR. The trimethoxysilane-terminated polyester obtained was used to formulate the adhesive.

### Example 2 (According to the Invention)

229 g of polyester polyol SS 4080 (Songstar) synthesized using an organotitanate catalyst and having a hydroxyl number of 29.4 mg KOH/g were heated to 90° C. with stirring. 22.4 g of (trimethoxysilyl)propyl isocyanate were added and stirred at 90° C. After 90 min, free isocyanate was no longer detected by FT-IR. The trimethoxysilane-terminated polyester obtained was used to formulate the adhesive.

### Example 3 (not According to the Invention)

240 g of polyester polyol SS 4080S (Songstar) synthesized using an organotin catalyst and having a hydroxyl number of 28.0 mg KOH/g were heated to 90° C. with stirring. 22.4 g of (trimethoxysilyl)propyl isocyanate were added and stirred at 90° C. After 600 min, free isocyanate was no longer detected by FT-IR. The trimethoxysilane-terminated polyester obtained was used to formulate the adhesive.

### Example 4 (not According to the Invention)

229 g of polyester polyol SS 4080 (Songstar) synthesized using an organotitanate catalyst and having a hydroxyl number of 29.4 mg KOH/g were heated to 90° C. with stirring. 63 mg of dibutyltin dilaurate as tin catalyst and 22.4 g of (trimethoxysilyl)propyl isocyanate were added and the mixture was stirred at 90° C. After 90 min, free isocyanate was no longer detected by FT-IR. The trimethoxysilane-terminated polyester obtained was used to formulate the adhesive.

### Example 5 (not According to the Invention)

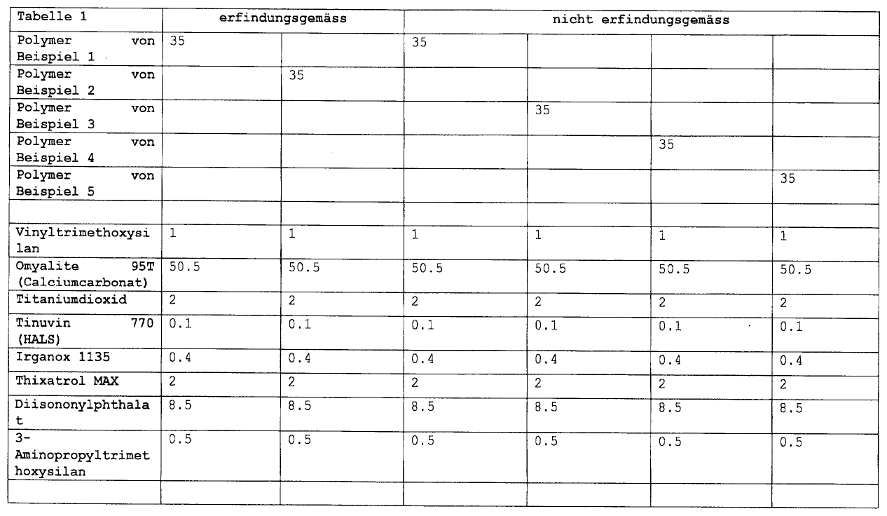

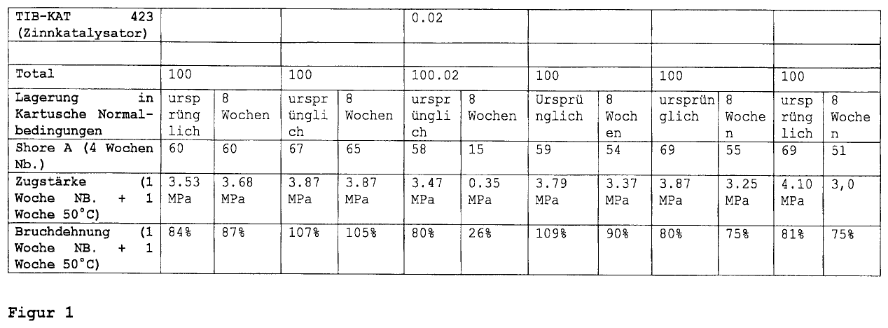

240 g of polyester polyol SS 4080S (Songstar) synthesized using an organotin catalyst and having a hydroxyl number of 28.0 mg KOH/g were heated to 90° C. with stirring. 75 mg of dibutyltin dilaurate as tin catalyst and 22.4 g of (trimethoxysilyl)propyl isocyanate were added and the mixture was stirred at 90° C. After 90 min, free isocyanate was no longer detected by FT-IR. The trimethoxysilane-terminated polyester obtained was used to formulate the adhesive. The results are presented in FIG. 1 (Table 1).

The final adhesive is only stable if no tin catalysts are present during the preparation of the hydroxy-terminated polyester, the reaction with the isocyanate silane and the formulation as an adhesive, sealant or coating material. Otherwise, the Shore A hardness (measured in accordance with DIN 53505) and the tensile strength (measured in accordance with DIN 53504) already decrease significantly after the sealant has been stored in a cartridge at room temperature for 4 to 8 weeks. At higher storage temperatures, the mechanical properties decrease even more quickly in the presence of a tin catalyst.

The tables below show the stability of the compositions after 8 weeks and after 32 weeks:

| | According to | | | Not according to | | |
|---|---|---|---|---|---|---|
| | the invention | | | the invention | | |
| Polymer, Example 1 | 35 | | | 35 | | |
| Vinyltrimethoxysilanes | 1 | | | 1 | | |
| Omyalite 95T (calcium | 50.5 | | | 50.5 | | |
| carbonate) | | | | | | |
| Titanium dioxide | 2 | | | 2 | | |
| Tinuvin 770 (HALS) | 0.1 | | | 0.1 | | |
| Irganox 1135 | 0.4 | | | 0.4 | | |
| Thixatrol MAX | 2 | | | 2 | | |
| Diisononyl phthalate | 8.5 | | | 8.5 | | |
| 3-Aminopropyltrimeth- | 0.5 | | | 0.5 | | |
| oxysilane | | | | | | |
| TIB-KAT 423 (tin | | | | 0.02 | | |
| catalyst) | | | | | | |
| Total | 100 | | | 100.02 | | |
| Storage of composition | initial | 8 wks | 32 wks | initial | 8 wks | 32 wks |
| at n.c. | | | | | | |
| Shore A (curing over 4 | 60 | 60 | 66 | 58 | 15 | (*) |
| weeks at n.c.) | | | | | | |
| Tensile strength (curing | 3.53 | 3.68 | 3.6 | 3.47 | 0.35 | (*) |
| over 1 week at n.c. + 1 | MPa | MPa | MPa | MPa | MPa | |
| week at 50° C.) | | | | | | |
| Elongation at break | 84% | 87% | 102% | 80% | 26% | (*) |
| (curing over 1 week at | | | | | | |
| n.c. + 1 week at 50° C.) | | | | | | |

| | According to | | | Not according to | | |
|---|---|---|---|---|---|---|
| | the invention | | | the invention | | |
| Polymer, Example 2 | 35 | | | | | |
| Polymer, Example 3 | | | | 35 | | |
| Vinyltrimethoxysilanes | 1 | | | 1 | | |
| Omyalite 95T (calcium | 50.5 | | | 50.5 | | |
| carbonate) | | | | | | |
| Titanium dioxide | 2 | | | 2 | | |
| Tinuvin 770 (HALS) | 0.1 | | | 0.1 | | |
| Irganox 1135 | 0.4 | | | 0.4 | | |
| Thixatrol MAX | 2 | | | 2 | | |
| Diisononyl phthalate | 8.5 | | | 8.5 | | |
| 3-Aminopropyltrimeth- | 0.5 | | | 0.5 | | |
| oxysilane | | | | | | |
| TIB-KAT 423 (tin | | | | | | |
| catalyst) | | | | | | |
| Total | 100 | | | 100 | | |
| Storage of composition | initial | 8 wks | 32 wks | initial | 8 wks | 32 wks |
| at n.c. | | | | | | |
| Shore A (curing over 4 | 67 | 65 | 65 | 59 | 54 | 55 |
| weeks at n.c.) | | | | | | |
| Tensile strength (curing | 3.87 | 3.87 | 3.88 | 3.79 | 3.37 | 2.83 |
| over 1 week at n.c. + 1 | MPa | MPa | MPa | MPa | MPa | MPa |
| week at 50° C.) | | | | | | |
| Elongation at break | 107% | 105% | 108% | 109% | 90% | 90% |
| (curing over 1 week at | | | | | | |
| n.c. + 1 week at 50° C.) | | | | | | |

| | Not according to | | | Not according to | | |
|---|---|---|---|---|---|---|
| | the invention | | | the invention | | |
| Polymer, Example 4 | 35 | | | | | |
| Polymer, Example 5 | | | | 35 | | |
| Vinyltrimethoxysilanes | 1 | | | 1 | | |
| Omyalite 95T (calcium | 50.5 | | | 50.5 | | |
| carbonate) | | | | | | |
| Titanium dioxide | 2 | | | 2 | | |
| Tinuvin 770 (HALS) | 0.1 | | | 0.1 | | |
| Irganox 1135 | 0.4 | | | 0.4 | | |
| Thixatrol MAX | 2 | | | 2 | | |
| Diisononyl phthalate | 8.5 | | | 8.5 | | |
| 3-Aminopropyltrimeth- | 0.5 | | | 0.5 | | |
| oxysilane | | | | | | |
| TIB-KAT 423 (tin | | | | | | |
| catalyst) | | | | | | |
| Total | 100 | | | 100 | | |
| Storage of composition | initial | 8 wks | 32 wks | initial | 8 wks | 32 wks |
| at n.c. | | | | | | |
| Shore A (curing over 4 | 69 | 55 | 43 | 69 | 51 | 45 |
| weeks at n.c.) | | | | | | |
| Tensile strength (curing | 3.87 | 3.25 | 1.86 | 4.10 | 3.0 | 1.64 |
| over 1 week at n.c. + 1 | MPa | MPa | MPa | MPa | MPa | MPa |
| week at 50° C.) | | | | | | |
| Elongation at break | 80% | 75% | 66% | 81% | 75% | 63% |
| (curing over 1 week at | | | | | | |
| n.c. + 1 week at 50° C.) | | | | | | |

n.c. stands for normal climate, 23′C, 50% relative humidity, * means no crosslinking within the specified curing time.

1. A process for preparing a silane-terminated polymer of the formula (I) or (II) 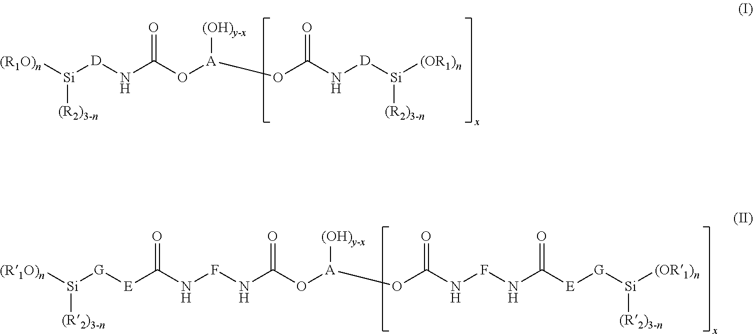
by reacting a hydroxy-terminated organic polymer of the formula (III) 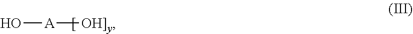
a) with an isocyanate of the formula (IV)
R²₃₋ₙ(R¹O)ₙSi-D-NCO (IV),
or
b) with a multi-functional isocyanate of the formula (V)
F—(N═C═O)ₘ (V)
and subsequent reaction with an alkoxysilane of the formula (VI)
R^{2′}₃₋ₙ(R^{1′}O)ₙSi-G-E (VI)
in the presence of a catalyst, wherein
D is a linear or branched hydrocarbon group having 1 to 20 hydrocarbon atoms, which may optionally be interrupted by heteroatoms selected from the group consisting of oxygen, nitrogen and sulfur,
A is a polymer backbone selected from the group consisting of a polycarbonate, a polyester, a copolymer comprising a polyester and/or a polycarbonate and a polymer comprising at least one ester group and/or carbonate group,
R₁, R₁′, R₂ and R₂′ are each independently a linear, branched or cyclic hydrocarbon radical having 1 to 10 carbon atoms, which may optionally comprise one or more heteroatoms selected from the group consisting of oxygen, sulfur and nitrogen,
n is 1, 2 or 3,
x and y are natural numbers between 1 and 10,
G is a linear or branched hydrocarbon group having 1 to 20 hydrocarbon atoms, which may optionally be interrupted by heteroatoms selected from the group consisting of oxygen, nitrogen and sulfur,
F is a linear, branched or cyclic organic radical which does not contain any isocyanate-reactive groups,
m is a natural number greater than 1,
E is a reactive group which reacts with the isocyanate group and is selected from the group consisting of NH₂, NHR⁴ and SH, wherein
R⁴ is a linear, branched or cyclic hydrocarbon radical having 1 to 10 carbon atoms, which may optionally comprise one or more heteroatoms selected from the group consisting of oxygen, sulfur and nitrogen,
wherein both the reactants used and the reaction are free from a tin catalyst.

2. The process as claimed in claim 1, wherein A is a polymer backbone selected from the group consisting of a polycarbonate, a polyester, a copolymer comprising a polyester and/or a polycarbonate and a polymer comprising at least three ester groups and/or carbonate groups, preferably from a polycarbonate, a polyester and a copolymer comprising a polyester and/or a polycarbonate.

3. The process as claimed in claim 1, wherein the polymer backbone comprises a branched diol component.

4. The process as claimed in claim 1, wherein the reaction is carried out with an isocyanate of the formula (IV)
R²₃₋ₙ(R¹O)ₙSi-D-NCO (IV).

5. The process as claimed in claim 1, wherein the silane-terminated polymer is a linear polymer of the general formula (IA)

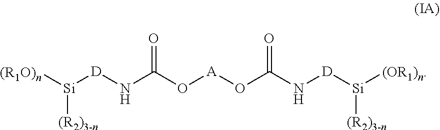

6. The process as claimed in claim 1, wherein the silane-terminated polymer is a branched polymer of the general formula (IB) 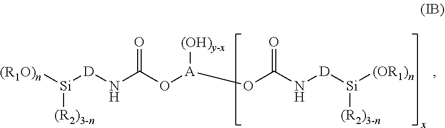
where x and y each correspond to a natural number between 2 and 10.

7. The process as claimed in claim 6, wherein the silane-terminated polymer of the formula (IB) is substantially free of free hydroxyl groups.

8. The process as claimed in claim 1, wherein both the preparation of the reactant and the preparation of the silane-terminated polymer of the general formula (I) or (II) are effected with the same catalyst.

9. The process as claimed in claim 1, wherein the reaction is carried out in the presence of a titanium-containing organometallic compound.

10. The process as claimed in claim 9, wherein the titanium-containing organometallic compound is selected from the group consisting of bis(ethylacetoacetato)diisobutoxytitanium(IV), bis(ethylacetoacetato)diisopropoxytitanium(IV), bis(acetylacetonato)diisopropoxytitanium(IV), bis(acetylacetonato)diisobutoxytitanium(IV), tris(oxyethyl)amineisopropoxytitanium(IV), bis[tris(oxyethyl)amine]diisopropoxytitanium(IV), bis(2-ethylhexane-1,3-dioxy)titanium(IV), tris[2-((2-aminoethyl)amino)ethoxy]ethoxytitanium(IV), bis(neopentyl(diallyl)oxydiethoxytitanium(IV), titanium(IV) tetrabutoxide, tetra(2-ethylhexyloxy) titanate, tetra(isopropoxy) titanate, tetrabutyl titanate, tetraisopropyl titanate, tetra-2-ethylhexyl titanate and titanium acetylacetonate and polybutyl titanate.

11. The process as claimed in claim 1, wherein the reaction is carried out in the presence of a further catalyst.

12. The process as claimed in claim 1, wherein the catalyst is not removed after the end of the reaction.

13. The process as claimed in claim 1, wherein the polymer backbone is a polyester.

14. The process as claimed in claim 1, wherein the isocyanate of the formula (IV) is selected from the group consisting of (isocyanatopropyl)trimethoxysilane, (isocyanatopropyl)methyldimethoxysilane, (isocyanatopropyl)triethoxysilane, (isocyanatomethyl)methyldimethoxysilane and (isocyanatomethyl)triethoxysilane.

15. A composition comprising a silane-terminated polymer as claimed in claim 1 for use as an adhesive, sealant or coating material, characterized in that the composition is free from a tin catalyst.
